(19) United States
(12) Patent Application Publication
(10) Pub. No.: US 2010/0258588 A1
(43) Pub. Date: Oct. 14, 2010

(54) MOVABLE POCKET FOR A DISPENSER AS DRINKS DISPENSING SYSTEM

(75) Inventor: Wolfgang Jobmann, Deutschland (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: WOLFGANG JOBMANN GMBH

(21) Appl. No.: 12/294,780

(22) PCT Filed: Mar. 28, 2007
(86) PCT No.: PCT/EP2007/052990

§ 371 Date: May 19, 2010

(30) Foreign Application Priority Data
Mar. 29, 2006 (EP) 06111903.8

(51) Int. Cl. B65D 37/00; B65D 75/58; B65D 35/56; B67D 7/80

(52) U.S. Cl. 222/105; 53/284.7; 222/1; 222/146.6

(57) ABSTRACT

The invention relates to a drink bag which has a pocket and makes improved cooling of the bottled drink possible via the pocket. The bag is filled with a drink and closed in a fluid-tight manner. It has a sealed dispensing section and a pocket which is attached to the flexible bag, protrudes freely into the interior of the drink-filled bag and is made from a material which is impermeable for the drink. In an inwardly lying position, the pocket has an opening to the outside for inserting a flat paddle element which has two sections. It is set in motion via the first section which lies outside the bag, with the result that this movement is transmitted to the drink filling by way of the second section which lies on the inside; this takes place together with the driving movement of the inner pocket which protrudes into the interior of the drink-filled bag.

### CROSS REFERENCE TO RELATED APPLICATIONS

This application is a U.S. National Stage Application of International Application No. PCT/EP2007/052990, filed Mar. 28, 2007, which claims the benefit of European Patent Application No. EP 06111903.8, filed on Mar. 29, 2006, the disclosure of which is herein incorporated by reference in its entirety. PCT/DE2007/052290 designated the United States and was not published in English.

### FIELD OF THE DISCLOSURE

Embodiments of the invention relate to a drink bag provided as a flexible bag, which comprises a pocket and which facilitates improved cooling of the filled-in drink through said pocket.

### BACKGROUND OF THE DISCLOSURE

EP-B 793 618 shows drink pouring devices which are filled with premixed drinks. An ongoing and substantial requirement of these drink systems is hygiene. When using disposable bags, this hygiene can be maintained reasonably well. The more hygienic these bags become and the more hygienic and antiseptic the content is packaged, the more difficult the access of a suitable cooling mechanism for the hygienically encapsulated system becomes.

Two techniques for the distribution and delivery to locally installed dispensing systems are presently being used. On the one hand, so-called bag-in-box units are in commercial use, which are filled with a bag-in-box drink. In a manufacturing plant, a finished drink is filled into bags, which are provided with a sealed delivery hose. The delivery hose is thus sealed. The drink is closed aseptically and the access to the drink in the carton only becomes possible when the carton is placed into a suitable refrigerator at the dispensing location, and the dispensing hose is cut open in order to be able to dispense the drink in portions in cooled state after respective cooling.

Without an outer packaging, drink systems operate according to the bag-in-bowl principle. Here the drink bag is also provided with a delivery hose, which can also be open as well as a filling end may be open for inducting drink components, including a concentrate and water, or an externally mixed drink. At the dispensing location, these bags are placed into a tub or a container in order to be filled with drink components thereafter. The dispensing is performed also here from a refrigerator, which fits into the system, and through the delivery hose, which does not necessarily have to be cut open, but which can be closed by said dispensing device through pressure, when inserted into the system compatible refrigerator, including a respective dispensing device. When dispensing in this manner, a filled in drink automatically does not run out and the delivery hose does not have to be cut open separately.

Both systems have been proven in practical applications, provide sufficient hygiene, but both are disposable systems. Due to the good hygienic properties, both systems have the disadvantage that they cannot absorb cooling sufficiently quickly. This capability to absorb cooling complies with the need to be able to be cooled down to a low temperature in a time frame that is as short as possible with reference to the drink fluid in the flexible bag (or also within the bag and the outer packaging). In the closed bag, or in particular, also in the outer packaging, the drink can receive time effective cooling only with difficulty. Thus, it is still required today to pre-cool the drink content of these systems over a longer period of time, either in a separate cooling space, in which the bag-in-box refill packages are initially stored before they reach the dispensing device, or to cool them over an extended period of time in the dispensing devices themselves, which were referred to as “suitable refrigerators” supra. Both pre-cooling methods require time, on the one hand, and increased energy input, on the other hand, which are improvement needs addressed by the invention.

U.S. Pat. No. 3,463,357 to MacLean illustrates a flexible bag in an outer packaging, wherein said bag comprises plural openings, which are most apparent from FIG. 2. A fill-in opening is provided, which comprises a sample section directly adjacent, which as a bag appendix, 20, comprises a narrow inlet and a slightly wider interior configuration, but a very small size compared to the main bag. Filled in filling material, among other things, liquids, or e.g. ice cream, are then not only filled into the main bag, 10, but also into the sample bag 20. Subsequently, the main inlet, 18, is closed, e.g. hot sealed. A dispensing spout disposed adjacent is slightly offset, not as close at the fill-in opening as the sample bag, but has a much larger cross section. It can also be cut open as illustrated in FIG. 6, in order to remove the filling material. The sample bag can be separated without causing an additional access to the main bag. Thus it can also be sealed by a hot weld spot at the bottleneck, in order to be separated then, and to be able to extract content samples. Said pocket solution or the bag thus has three accesses, two of which are permanently closed. One of them can be separated for samples and cannot be opened. The other one, however, can yet be opened for the extraction. A direct application for storing liquids and for the extraction of drinks is not described therein; also there is no disclosure that the content of the drink has to be cooled quickly.

U.S. Pat. No. 5,685,875 to Hlavinka is comparable and disposed in a further removed field of keeping biological fluids sterile, wherein said patent also operates with an appendix, which receives a portion of the fluid and can be separated as illustrated in FIG. 2. The hermetic cut off and the physical separation of this smaller bag cut off guarantee the sterility of the remaining filling material maintained.

The bag shape of U.S. Pat. No. 3,430,815 to Weimer points more in the direction of preparing a mixture of various contents and is primarily directed towards mixing tartar, and not to perform the mixture in a separate container, but in a bag, which is initially sent to the restaurant, refilled with tartar, where the tartar is mixed together with the additional ingredients little by little by filling the ingredients into another fill opening, which is cut open before. Subsequently, the bag is closed anew and the tartar and the ingredients are kneaded together in the bag in order to get mixed as illustrated in FIGS. 2, 3 and 4. The inlet is closed initially and is then opened and receives the ingredients. The first inlet, 18, through which the tartar was filled in, and is subsequently closed after filling in. The entire content is dispensed through another outlet 16 after mixing, which was initially sealed tight. Also here, comparable to the documents mentioned above, a shape of the bag is described, which comprises plural openings and at least one outlet, which need to be opened and closed at different points in time.

U.S. Pat. No. 6,244,023 to Lataix discloses a bag which also includes an inlet, a bottleneck and an associated outlet. The inlet can be cut open in order to introduce products and compressed air at this location. This shape of the container and its application, however, are very remote from the invention presently claimed.

These and other drawbacks exist.

### OBJECTS OF THE DISCLOSURE

Thus, it is an object of the invention to at least maintain the hygienic achievements of the state of the art in the sector of drinks, and to significantly accelerate the cooling methods, respectively to facilitate the cooling, or on the other hand to reduce the energy requirement of the cooling. Also, an acceleration of the cooling of the drink while reducing the cooling expenditure is a component of the technical object thus described.

### SUMMARY OF THE INVENTION

The flexible bag according to embodiments of the invention include a bag, which has not yet received a drink, a flexible bag, which is already filled with a drink, and a flexible bag in conjunction with a box type container (bag in box packaging), which already comprises a filled-in drink in the container and the flexible bag. An outer packaging of the flexible bag can include a cardboard packaging for the box type container. The flexible bags according to embodiments of the invention can also be delivered without this packaging, even without an already filled-in drink, in order to be filled with drink components (drink concentrate and water) at the location where the drink is used, and/or filled in and/or poured.

Embodiments of the invention also include dispensing system, in which a movable surface element is introduced in the flexible bag, and a method which can either be interpreted as operating method, or as a use for the flexible bag.

### BRIEF DESCRIPTION OF THE DRAWINGS

The invention is subsequently described in more detail with reference to embodiments in order to supplement and emphasize the description of the claimed invention:

FIG. 1 illustrates a first embodiment of an eversible pocket, disposed on the outside of a flexible bag, which can be everted towards the inside. The illustration is schematic and the walls of the flexible bag, which are drawn in dashed lines and illustrated in a sectional view, are depicted with exaggerated thickness for reasons of clarity.

FIG. 2 illustrates an exemplary embodiment of an application of the flexible bag according to FIG. 1, depicting of the thin wall of the bag with a flat movement element 40′ which is inserted into the inward protruding bag 20′, wherein the flat movement element is designated as movement element or paddle element.

FIG. 3 illustrates an exemplary embodiment of a flexible bag in an outer packaging as a bag-in-box, wherein the outer packaging 9 receives a flexible bag, which has an inward protruding bag 20, which includes a liquid tight seam 25 at the rim. Flat movement element 40 protrudes into said bag, which may be movably supported about a horizontal axis 51.

FIG. 4 illustrates the exemplary embodiment of FIG. 3, having the flexible bag 10, the inward protruding pocket 20 and the insertion opening 21, which is open to the outside with this respect, for a flat movement element 40 or 40′ according to one of the FIG. 2 or 3.

FIG. 5 illustrates an enlarged view of an exemplary embodiment of an inward protruding bag having an inner flat stiffener 26, which can include two plates 26a, 26b. The longitudinal rims may extend in parallel.

FIG. 6 illustrates an exemplary embodiment of a flexible bag for receiving drinks.

FIG. 6a illustrates an exemplary embodiment of a flexible bag for receiving drinks.

FIG. 7 illustrates an exemplary embodiment of a flexible bag for receiving drinks.

### DETAILED DESCRIPTION OF THE DISCLOSURE

The following description is intended to convey a thorough understanding on the embodiments described by providing a number of specific embodiments and details involving a drink bag having a movable pocket for a dispenser and associated operating methods. It should be appreciated, however, that the present invention is not limited to these specific embodiments and details, which are exemplary only. It is if further understood that one possessing ordinary skill in the art, in light of known systems and methods, would appreciate the use of the invention for its intended purpose and benefits in any number of alternative embodiments, depending on specific design and other needs.

In exemplary embodiments, the interior content, thus the drink components of the bag, when filled, can be kept in motion in the dispensing device. This movement can be designated as stirring, pivoting or pendulum movement. It is a movement imparted upon the liquid from the outside, which does not lead to a stirring wing or a stirring paddle, or another stirring device coming in direct contact with the drink, but that it is shielded by a shielding in the form of a bag made of bag material. The movement in the drink is accomplished without opening the closed bag, and without the stirring mechanism coming into direct surface contact with the drink. The associated pocket, which either already reaches into the drink or only reaches into the interior of the bag, when the bag is not filled yet, or which still protrudes to the outside as an eversible bag, in order to be subsequently put into the inward protruding state, is a component which facilitates said solution. Into the then inward protruding inner pocket or the inward everted outer pocket, the movement element, which is designated as a paddle element here, is inserted in order to transfer the movement to the drink through the linked movement of the inward protruding pocket. The “stirring movement of the drink” in the form of a forward- and backward pivoting of the paddle with pocket and a respective transfer of said movement to the entire liquid content facilitates a fast energy output in the form of a heat extraction from the liquid through the remaining walls of the bag, or also of the outer carton, at whose inner wall the moved liquid passes more quickly, and can thus better dissipate the heat from the liquid content.

Since the flat movement element (the wing in the sense of the paddle element) is disposed shielded in the drink and the fluid pressure of the drink loads all sides equally, said liquid force balances itself out when the wing is moved, and it can be moved easily in the bag and with the bag in the drink. In order to overcome said force only that force is necessary, which is being transferred through the movement of the paddle in the liquid as such, and said force is proportional to the speed. Thus, when the wing moves slowly, it imparts a gentle slight and continuous movement into the liquid. Thus, it facilitates the circulation of the liquid and the circulation at the interior walls of the pocket, from where the heat removal from the liquid can be performed more quickly and in a more targeted manner than when the liquid remains stationary.

It can be avoided through the proposals according to the invention that the wing according to various embodiments does not come in contact with the drink, and there is therefore no reduction of hygiene.

The direction in which the surface element for circulation is inserted can be selected in rather discretionary manner. Starting at the top, the surface element can also be inserted into the pocket, which also starts at the top. For this purpose, said pocket comprises an outward protruding opening. The same can also be performed from all four sides of the bag. Then this is a lateral induction of circulation movements, also through the shielding pocket. Also, an imparting from below is possible at a distance from the output section. The drink delivery system including the inserted liquid tight bag, in particular in a box type container or in a tub shaped cooling container, is suitable for cooled dispensing of a drink.

A pocket may be provided, which may be made of a material impermeable for the drink, which protrudes into the interior of the drink filled bag. The pocket, which may be provided as an inner pocket in a position situated in the interior, has an opening towards the outside. A flat movement element (paddle or wing) may be inserted therein. The movement element has two sections.

The movement element can be brought into a pivoting movement through its first section, which is located outside of the bag. This movement can be transferred into the drink filling by the inserted second section of the flat movement element.

The transmission may be performed by the inner pocket as a moving unit, which may follow the movement of the movement element, and which may protrude into the interior of the bag and seal the flat movement element towards the drink.

According to various exemplary embodiments, the method for operating the drinks dispensing system or the method for providing a cooled drink for a portion wise dispensing from the dispensing system operates with the flexible bag. The bag receiving the drink may have a pocket. The pocket may be provided for the interior cavity of the drinks bag, thus it is disposed therein, or can be everted into it.

When the pocket is disposed on the inside or everted towards the inside, it may receive a movement wing, which may be inserted from the outside. Both positions and directions may be covered by the designation “provided for the interior”. When the inner pocket is already on the inside, the wing may be introduced. When the inner pocket is on the outside, it can be moved to the inside before or during the insertion of the wing. The interior is the interior of the main bag.

The movement paddle may be moved from the outside in order to circulate the drink without coming into direct surface contact with the drink.

The flexible bags according to various exemplary embodiments may have a capacity of between approximately 10 and 20 liters, and may be filled from the top. The dispensing hose may be oriented downward. The materials, from which the flexible bags can be produced are flexible enough and preferably also transparent, so that they may have no stiffness, and may facilitate a sufficient movement in the joint area, where the inner pocket transitions into the bag wherein said movement corresponds to the pivoting movement of the flat element. The shapes, in which the bags are provided, also may be selectable within rather wide limits. Bag shaped packaging can be used in the sense of a rectangle or cuboid, which may be bulged outward on two sides, or a cuboid, which may be used with box type outer packaging, or also cylindrically formed containers, which have an upper and a lower plane, which is connected to a cylindrical enveloping surface. The walls of the containers thus formed may be mostly very thin, but sufficiently stable to resist the water pressure, as far as they are not supported by an outer packaging, or supported by the refrigerators or dispensing devices while getting filled in as bag-in-bowl containers. In so far, only the sealing function of the thin walls is required, wherein the thin walls also assure hygienic conditions.

According to various embodiments, polyethylene may be a suitable material for the foil material of the flexible bags. Other plastic materials can also be used as long as they are sufficiently flexible, at least in the section where the pocket is disposed, into which the flat element may impart a movement up to the transition portion, which is disposed between the pocket and the rest of the bag. This movement may be relatively small at the outer rim, when the axis of the movement is close to the transition portion between the pocket and the bag, so that the main movement may be at the front end of the surface element, and therefore also the main movement of the inward reaching pocket may be performed at its most forward end.

The advantages accomplished by various embodiments are that the cooling does not require more than two hours, mostly even less, since already after one hour, a bag-in-box system according to various embodiments or a bag-in-bowl system also according to various embodiments is cooled down to a dispensing temperature. No particular cooling spaces are additionally required, since the cooling may be performed in the dispensing device and the hygiene does not suffer here.

The flexible bag, which may be closed and filled with drink, is liquid tight, when mounting an outer packaging, it also may be stable for transport. The sealed dispensing hose can already be provided when producing the bag and does not have to be closed additionally during the filling process. The sealed dispensing hose may be disposed liquid tight at the container, and may extend as a cylindrical sleeve element, wherein the pocket reaching into the interior of the bag can already be disposed in the interior when the drink is filled in. The bag according to this embodiment may be reinforced by inserted plate elements, which facilitate inserting the flat movement element at the setup location of the drink dispenser. These plates can be configured from cardboard and can include two layers between which the flat element is inserted, thus damage to the inward protruding bag can be avoided.

The flat movement element can be configured like a spatula, thus with a tapering of its longitudinal edges, which is performed towards the front, so that a section is conically tapered at the frontal flat end without a risky point.

A pivot axis of the flat paddle element can be configured approximately in the middle of the length. Also, a non-symmetrical configuration of two sections of said paddle element is possible, wherein the outer section has a shorter length than the section moved in the drink, and has an outward disposed drive device, e.g. a cam drive or an eccentrical drive, and wherein the outer section imparts a movement onto the drive surface configured as a drive section. This movement may be then transposed through the axis as a pivot axis into an opposite movement of the paddle section in the drink (respectively shielded from the pocket, which also reaches into the drink). The flexible bag is thus impermeable for the drink; the pocket has an outward protruding opening in order to be able to insert the paddle element into the inward protruding bag.

According to various embodiments a bag-in-box system may also be provided. The flexible pocket thus does not have to reach into the interior of the bag, but can furthermore be disposed as an eversible pocket, which reaches towards the outside, or it can be mounted so it lies flat on the outer cardboard, wherein it protrudes through the outer cardboard to the outside. The opening slot, which may be implemented for this purpose in the outer cardboard, may be later used to insert the pocket, which may be configured as an eversible pocket, into the interior of the filled bag, which can be performed through the double plate elements in order to prepare the slot for the movement element to be inserted, or the insertion of the outward disposed pocket into the everted inward protruding state can be performed by the flat element. Thus, the flat element may be inserted together with the outward disposed pocket through the slot of the outer packaging, in order to reach the operating condition.

In the bag-in-bowl arrangement, the insertion of the pocket may be performed before or after filling the drink as described above, only without the outer packaging. Also, in this embodiment, in the inward protruding state of said pocket, an outward facing opening, mostly slot shaped, may be provided to be configured to receive the flat element to cause the movement.

The connection between the bag either provided as an eversible pocket or as a pocket already protruding inward (inner pocket) to the remaining flexible bag can be performed through a connection seam, which can be configured as a welded or sealed seam, however, on the other hand, an integral configuration of the bag can also be provided, in which the bag configured as an eversible bag may be disposed outside of the inner cavity, and everted inward at a later point in time.

Such a bag shape, has an opening section, a dispensing section and initially, an outward protruding pocket, which may be suitable and configured to be everted in the interior of the bag, in which state it takes over the shielding of the flat paddle element at the installation site, and assures that hygienic conditions are maintained, but the cooling is accelerated by orders of magnitude, which also reduces energy consumption, and reduces the cost of storage for pre-cooling rooms.

It has become apparent from the description above that a movement unit is provided in operating state, which may be formed by the inward protruding pocket and the flat movement element inserted therein configured as a paddle element. This movement unit may provide some of the advantages of the invention.

In exemplary embodiments, the pocket can be configured greater in length than in width. Also, the dispensing section can be configured hose shaped. Thus it also has a greater length than its associated diameter. The pocket can comprise parallel longitudinal rims.

The pocket also can be defined by the liquid tight seam relative to the bag, as described above in more detail. Naturally, the seam also may be liquid tight then and may provide an improved and mechanically more stable transition zone, in which an inner kneading movement may occur in the bag material, which, however, can be significantly reduced, when the axis of the pivoting movement of the flat paddle element is disposed close to the liquid tight seam between the pocket and the rest of the bag (in the operating state of the dispensing system).

According to various exemplary embodiments, the two systems of bag-in-box and bag-in-bowl are implicitly described. The embodiment of a flexible bag is common to both of them. In one embodiment, the bag may be independent and in another embodiment, the bag may be provided in an outer packaging, configured as a box, which can be considered as a box type container. Further embodiments can be considered.

It is appreciated that the figures are schematics, which are neither drawn to scale with respect to their lateral and vertical extension, nor realistic with respect to the thickness of the wall of the flexible container 10. It shall furthermore be emphasized, which possibilities of movement and forming pockets and spaces are provided in the flexible container.

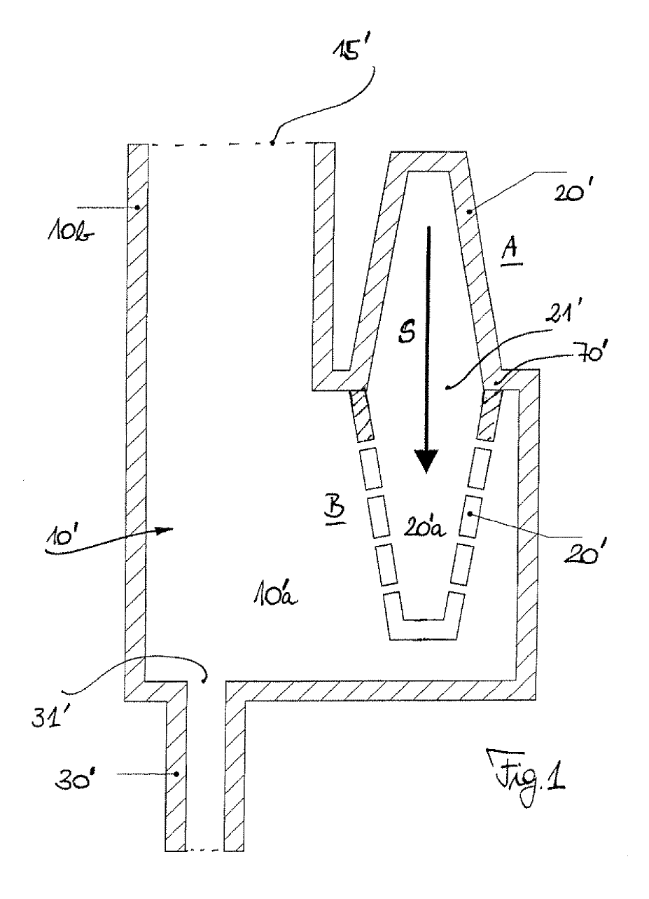

FIG. 1 depicts an exemplary embodiment of a container 10′, which may include an upward pointing opening 15′, and offset therefrom, an initially outward protruding configuration 20′ as an everted pocket in a first outer position A. On the opposite end, a dispensing section 30′ may be provided, which can be closed, but which is illustrated in an open configuration in FIG. 1. Before filling bag 10′ with a drink or with a mix of the drink components water and drink concentrate, bag 10′ may be placed into a tub shaped container, not shown, in which the dispensing hose may contact a dispensing device in a sealing manner, and the outward protruding pocket 20′ may be brought into an inward protruding second state B, which is illustrated in dashed lines in FIG. 1. The pocket 20 may be everted inward here. The inward protruding state B and the outward protruding state A, however, are generally understandable terms.

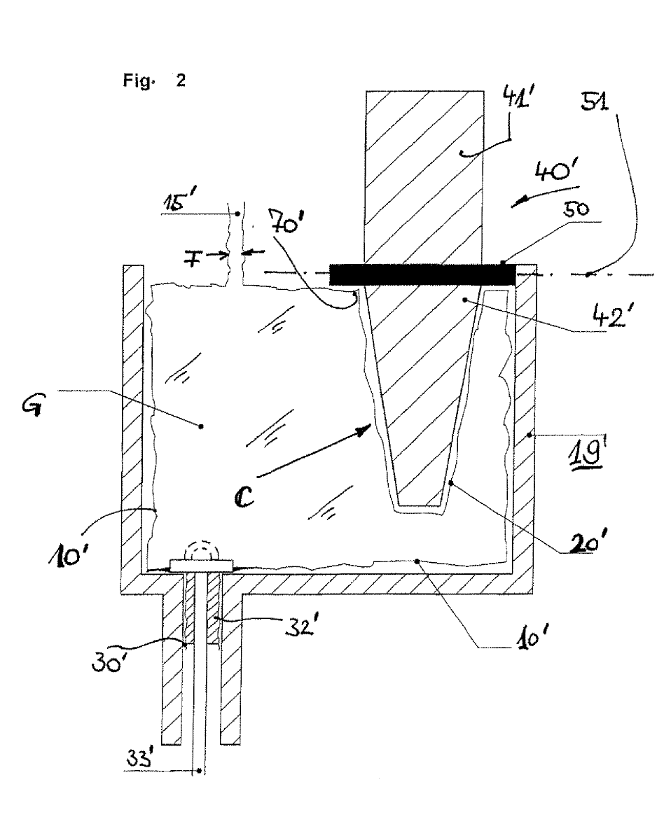

The described step of inserting a flat movement element is illustrated in FIG. 2, in which a bag assembly 10 according to FIG. 1 is illustrated in a tub shaped receiver 19. This receiver tub is to be considered as a bowl and may include cooling devices and other control devices, not shown in detail, such as, e.g. a device for controlled dispensing of the drink G, which may be stored in bag 10, is cooled therein, may be cooled down before and is stored in a manner assuring hygiene. Through the dispensing device, which is configured as a hose 33 and a seal 32′, the dispensing hose 30′ may be connected to the output, wherein the control mechanism, which is not described in more detail, may be provided for dispensing the drink G. For this purpose, the output 30′ may include an inward protruding opening 31′, which is shown in FIG. 2 in closed state, and which may be connected to the control device for portioned dispensing of the drink through a guide and guidance element, which may lead into the dispensing hose 33′.

The bag 10′ of FIG. 1 may have a bag wall 10b, which may surround the exterior and which also may define a section of the filler opening 15′, which is open to the top. The outward protruding eversible bag 20′ in the position A may be connected to the remaining flexible container 10′ through a flexible connection 70′, which may completely surrounds the eversible bag at its lower end in the position A and at its upper end in the position B. Here, a liquid tight connection may be provided which may permit a certain flexibility and a permanent loading in the sense of a movement to a limited extent. Before filling the drink components into the fill opening 15′, the outward located pocket 20′ may be brought into the state where it is located towards the interior according to the eversion arrow S. The eversion towards the interior may be done by hand, for example, since all inner walls of the eversion pocket are aseptically oriented towards the interior, and are not contaminated by a contact with the hand surface from the outside, so that said change comes in contact with the drink filling. Thus, the position B of the inward everted pocket may be created, in this case, it may be an inner pocket or an everted pocket, which is capable of receiving a flat moving element. This element is then shown in the inserted position in FIG. 2.

The embodiment of the flexible bag according to FIG. 1 may be provided for receiving a drink, storing the drink in the respective position in a tub or in a box type container, and storing the drink there until it can be dispensed in portions over a longer period of time. Before and during the portioned dispensing, cooling may be performed, which is provided through the drinks dispensing system, configured as e.g. a refrigerator or a cooling device. The dispensing hose 30′ can be closed, and the filler opening 15′ can also be closed. When the drink components have been filled into the flexible bag through the opening mentioned above, then the opening 15′ may be cut off through a transversally acting force F, as shown in FIG. 2. The pocket 20′ connected to the remaining bag 10′ may be made from a liquid tight material, e.g. polyethylene like the bag. The wall 10b of the bag may be thin, quite flexible and may be supported by the container wall 19 in filled state. In this embodiment, the bag is liquid tight and hygienically safe.

In the inward protruding state of the pocket 20′ (position B of FIG. 1) and with the flat movement element inserted according to FIG. 2, an upward protruding opening 21 may be created, which is defined by the joint 70, e.g. a circumferential seam or a circumferential seal. The opening may be used for inserting the flat movement element 40′, for filling the drink into the interior cavity 10a of the bag 10, in order to facilitate this insertion.

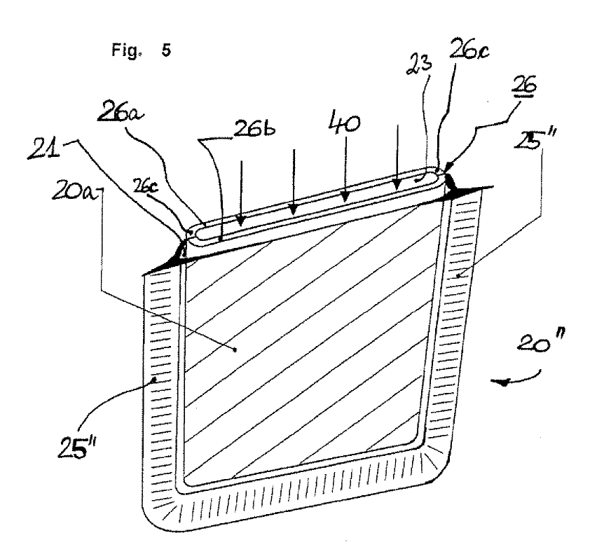

In the position disposed outside of the remainder of the bag 10′, the eversion pocket 20′ may be configured so that the eversion pocket 20′ can be freely everted into the interior of the bag 10′. This can preferably be performed before filling in the drink components, however, it can also be performed thereafter, e.g. in combination with adding a flat support and stiffening device as described with reference to FIG. 5. In the filled in state according to FIG. 2, the movement devices 40′ and the inward protruding bag 20′ may form a movement unit C.

For this purpose, the drink G is shown filled in and the opening 15′ is illustrated in the state where it is just being closed. When the content is closed, the drink can be removed through the dispensing hose 33′ and this removal can be performed in portions and upon request. Before that, the unit with the tub receiver 19 may cool the content G down to temperatures above 0° C. and into a range below 10° C. This cooling is not performed without the influence of a movement, which may be imparted by the flat movement device 40′. Through the existing movement unit C, the flat device 40′ can move in the drink G without coming into direct surface contact with the drink. The inner pocket 20′ (the inward protruding everted outer pocket) may protect the surface of the flat movement device 40′ in its lower portion 42′, which may move back and forth in a pivoting movement about the axis 51. This movement may be transmitted by the outward protruding flat section 41′, wherein a drive device may be provided, which is not shown here in detail, e.g. as cam or eccentric tappet, which may impart a reversing movement into the upper section 41′. Thus, a reversing movement may be imparted upon the lower section 42′, which may bring the drink G into a movement together with the bag 20′, wherein the movement can be characterized as revolving or stirring in the sense of a non-rotating movement.

The resulting movement potential in the drink G facilitates that all portions of the drink pass the wall portions of the tub 19 almost constantly, where they are cooled and where they transfer said cooling further into the interior of the drink, or they are being moved there through the movement of the paddle device 40′. A much faster and more effective cooling can be performed through the removal of heat at the inward protruding wall surfaces of the tub 19. Durations under two hours are accomplished for cooling a drink with a volume between 10 liters and 20 liters with starting temperatures above 20° C. First tests with embodiments of the invention, which are described in more detail, have resulted in cooling times which are smaller by the factor of 10 than those which are typically accomplished through convective cooling.

In order for the movement device 40′ to be able to perform pivoting movements, an axis 50 may be provided, which may be supported on a roller bearing, which is not shown in detail, but which may provide a rotation axis 51, which is coaxial with the shaft 50. Thereby, a movement into the plane of the paper and out of the plane of the paper can be imparted upon the upper section 41′, and transposed into a respective opposite movement of the inward protruding section 41′, which may move together with the pocket 20′, wherein the connecting seam 70′ may be provided as a real sealing seam with a striped circumferential shape, or as a pure transition link with an integral shape, which experiences an interior kneading movement or load, which, however, is small. The axis 51 may be proximal to the sealing seam 70′, so that hardly any movement of the bag occurs, and thus a low risk of breaking or crack development is present in the section of the bag holding the fluid.

Exemplary embodiments of the eversible bag 20′ can be provided as a bag that is welded close, comprising a sealing seam, or as an inner bag, which is welded in, wherein said bag then may not have to be everted, but is already disposed in a position, which corresponds to the position B, within the interior 10′a of the flexible bag 10′.

The shape of the inward protruding bag 20′ can be selected rather freely. This shape may be longer (higher) than wide, and may have a downward tapered shape with a flat end in this embodiment. The complementary shape of the flat movement element in the second section 41′ may be spatula shaped. A support may be approximately performed in the center along the longitudinal extension of both sections 41′, 42′ as it is substantially drawn by the axis 41. This support by means of the axis 51 substantially also may be provided in a portion 70 of the flexible bag.

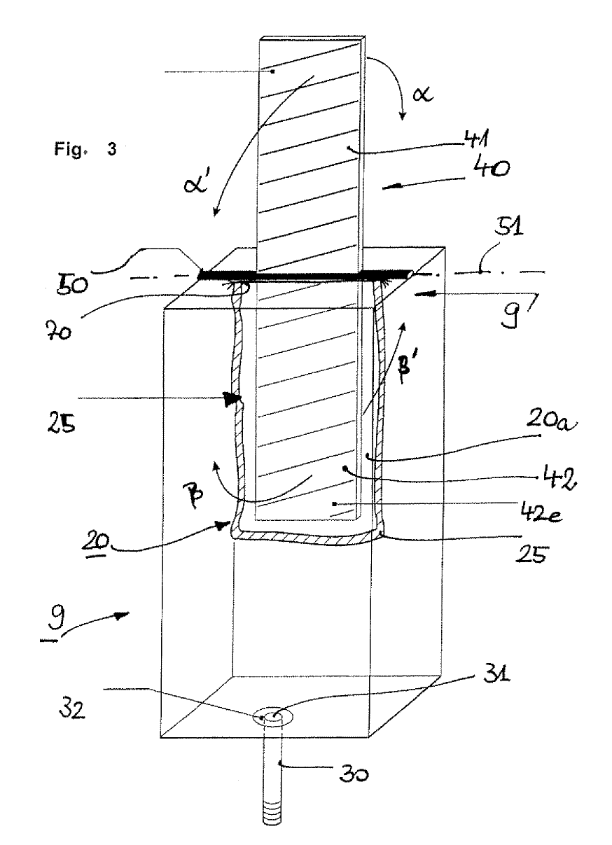

FIG. 3 illustrates an exemplary embodiment of a bag with an approximately cuboid outer carton, which may have a greater height than width. The outer carton 9 may be provided as a box of a flexible pocket which may be configured similarly and may operate in a manner similar to that of the embodiments described above. In this embodiment, the box type container may be provided with the flexible bag on the inside, and a drink may be filled into the flexible bag, which already may be closed on top. The use may be the same, the flexible bag holding the drink is hygienically proper for the drink, and the exterior carton may provide the stability, which also makes it transportable.

A dispensing section 30 may be configured hose shaped and may include an annular seal 32 which may surround an inner outlet opening 31 which may lead into the hose 30 which can be coupled to a dispensing system. For this purpose, the container 9 may be inserted into a respective receiver of a refrigerator or of a cooling device, which are not shown, but which are generally known as dispensing devices. These cooling devices may provide cooling in order to cool the drink in the interior of the flexible bag and in order to provide a controlled portioned dispensing through the delivery hose. The cooling effect in the inserted state goes through the outer packaging and heat is thus removed from the liquid in the interior in order to cool the drink down to a temperature of below 10° C.

The filler opening, which may be provided for the flexible container, cannot be seen anymore in the closed assembly of FIG. 3. However, a slot may be open to the top, which may lead into the interior 20a of the inward protruding bag as an inner bag. Herein, a movement device may be provided as a flat paddle 40, which may correspond to a straight flat plate shape, which may include an upper section 41 and an inward protruding section 42, whose lower end 42e abuts to the lower flat end of a seam, which may define the inward protruding bag 20 leak proof. The sides may be substantially parallel.

The inward protruding bag 20 may be made of a liquid tight material, e.g. polyethylene, and thin enough, so that it has sufficient freedom of movement, in order to be able to transfer a pivoting movement α, α′ of the outer section 41 to the inner section 42, here as a movement β, β′. The flat section 42 inserted into the pocket 20 may form a moving unit with the pocket, similar to the moving unit C of FIG. 2, and may facilitate a pivoting and thus imparting a movement into the drink in the interior of the flexible bag. Thus, the cooling becomes better, the drink may be circulated and may move more often along the inner walls of the flexible bag, in order to have energy removed there from, which is caused by the cooling on the outside. It is not required to remove the outer packaging. It can still be available in the inserted state.

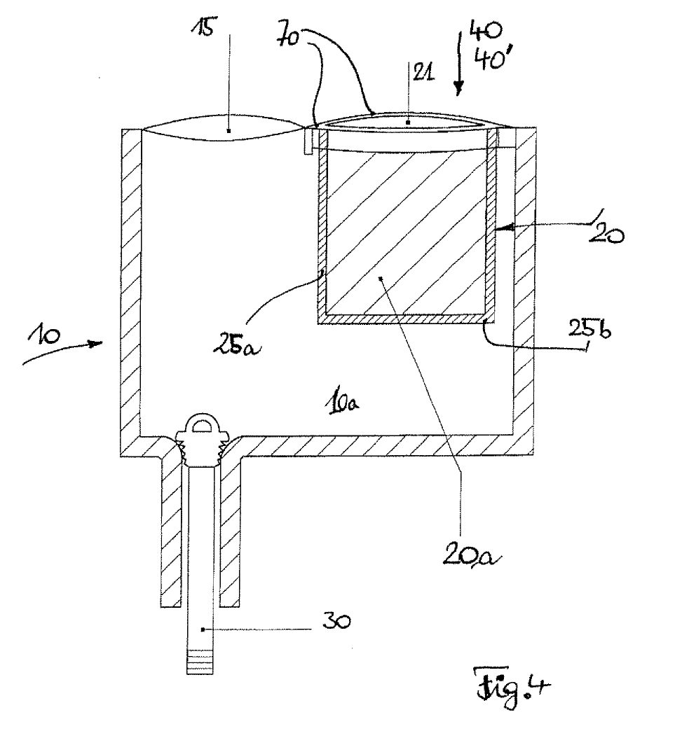

The upward facing opening 21, through which the flat movement element 40 may be inserted, is defined in the embodiment by a liquid tight seam 70, which can be seen more clearly in FIG. 4, when the movement element 40 is removed.

It is evident that the pivoting movement of the shaft 50 can be performed together with the movement element 40 (these are rigidly connected) about the axis 51, and may impart a movement upon the drink. The axis 51 may be disposed proximal to the seam 70; the loading of the seam 70 is thus very limited, so that it is not at risk. The movement unit C also in this case moves the drink portions along, which may be in the vicinity of the lower section 42, and may distribute this movement over the entire content of the bag in order to accelerate cooling in order to reduce the energy necessary to quickly provide a cooled down drink in the dispenser.

The state of an inward protruding pocket is shown in FIG. 4 for an exemplary bag as it is used in FIG. 3. Herein, the opening 15 is not closed yet, the outer packaging 9 does not exist yet, and the bag 10 is not filled yet. The pocket 20 with its flat extending interior 20a and its upward protruding opening 21 may be configured to receive the flat movement element 40 or 40′. A sealing seam 25 defining the pocket at the rim made of vertical sections 25a and a horizontal section 25b may be liquid tight and wide enough, e.g. approximately 1 mm to 5 mm. The inner pocket 20 thus formed is not an eversible pocket. It may be configured right from the beginning, so that it may protrude into the interior 10a. Towards the top, a slot shaped opening 21 may be defined by a sealing circumferential seal seam 70, which may be provided liquid tight. The exemplary bag shape according to FIG. 4 can also be produced separately without outer packaging and has a relevance of its own. Its shape at the rim does not have to have a seal seam, but can also be configured from an integrally formed bag, which may be provided in the portion of the inner bag with a seal seam 70, which creates a welded in inner bag.

FIG. 5 shows a detail of an exemplary embodiment of an inward protruding bag. This detail can be transposed to all embodiments mentioned above, but in particular to those embodiments in which the inner pocket 20 or 20′ already reaches into an inner cavity, and wherein the inner cavity 10a of the flexible container is filled with a drink. Thus, it is advantageous, when two flat plate portions 26a, 26b with a longitudinal and transversal extension are provided, which fit into the interior 20a of the pocket 20″ defined by the seal seam 25′. Thus, they have a slightly smaller width and approximately the length (depth) of the pocket or its inner cavity 20a. Two flat plates may be inserted into the upper opening 21 of the inner cavity, e.g. made out of cardboard, corrugated cardboard, or thin plastic strips. A slot may be formed between them, which can thereby still be enlarged, so that said plates on the rim side have an inward oriented arc shaped form 26c, which may abut to one another at the rim of the respective plate insert, in order to make the opening 23 between the two plates wider.

The flat movement element 40 or 40′ can be inserted into the preformed opening thus created, which may not be loaded by the liquid pressure and has thus been reduced to almost zero. It can then be brought into a pivoting movement after insertion, in order to form a movement unit together with the plates and the inner bag 20′, which may shield the paddle element liquid tight.

The insertion of the plates 26a, 26c can already be performed at the manufacturer. This is advantageous in particular, when it is a bag-in-box assembly, into which the liquid is already filled at the manufacturer. The inserts of the plates can also relate to the bag shape according to FIG. 1, in which the liquid is only filled in at the dispensing location, where the drink dispenser is located.

The advantages of the described embodiments are maintaining hygiene and avoiding a pre-cooling in separate cooling rooms. Compared to drinks, which do not have aseptic bags for packaging, the advantage lies in particular in the area of hygiene, in combination with a possibility to achieve fast cooling down. A cleaning or a cleaning step can be omitted due to the disposable packaging. This provides a much more flexible and faster availability of the cooled drinks, in particular for the system bag-in-box.

Deployment locations can also be served, which do not have cooling rooms, in which the delivered box assemblies are cooled down before use in the dispenser.

The stirring wing (the movement imparting flat paddle wing) can also be switched off after cooling down. The drink temperature thus achieved can also be maintained through regular cooling. It can then be removed or simply left in the unit without continuing to operate it.

It is a secondary effect of such movement wing to circulate drinks or juices which contain fruit pulp, in order to evenly distribute the fruit pulp in the entire liquid content. Here, an additional effect on top of the circulation and movement occurs, which goes hand in hand with additionally improved cooling.

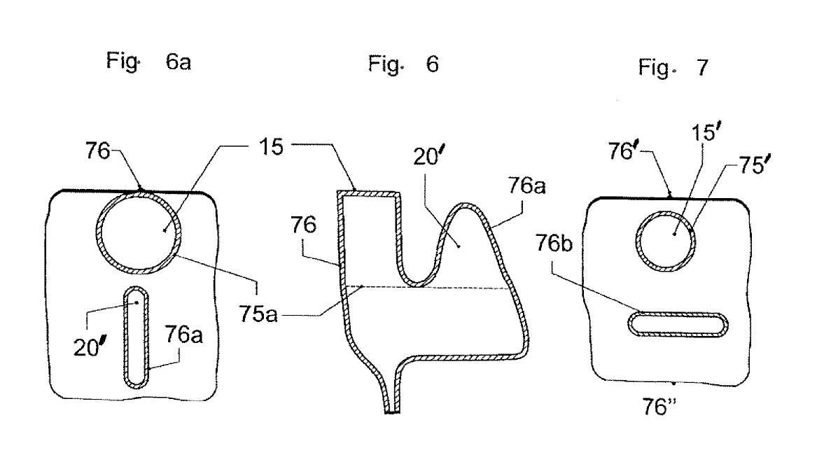

In FIGS. 6 and 7, sectional views of exemplary flexible containers are shown. In FIG. 6, the fill-in opening 15 may be provided, and a rim side seam 76 may define the shape of the container. A cut in the direction through the fill-in opening and through the pocket disposed on the interior is shown, wherein the pocket may be defined by a seal seam 76a. The eversion pocket defined by said seam 76a may extend in parallel to the seam 76, which may define the opening 15 over a certain portion, but defines the left rim of the container. The fill-in opening 15 may be defined itself by the seal seam 75a in the transition to the main bag. The view from the top with reference to FIG. 6 is illustrated in FIG. 6a as a horizontal cut on the plane of the seal seam 75a.

An exemplary embodiment having a vertical alignment of the eversion pocket, which may be defined by the seal seam 76b, is shown in FIG. 7. Here, the lateral seal seams 76′, 76″ are illustrated, so that they extend perpendicular to the extension of the eversion pocket, contrary to the parallel alignment of the seal seam 76 and of the eversion pocket 20′ of FIG. 6.

The embodiments of the present inventions are not intended to be limited in scope by the specific embodiments describe herein. Thus, modifications are intended to fall within the scope of the following appended claims. Further, although some of the embodiments of the present inventions have been described herein in the context of a particular implementation in a particular environment for a particular purpose, those of ordinary skill in the art should recognize that its usefulness is not limited thereto and the embodiments of the present inventions can be beneficially implemented in any number of environments for any number of purposes. Accordingly, the claims set forth below should be construed in view of the full breadth and spirit of the embodiments of the present inventions as disclosed therein. While the foregoing description includes many details and specificities, it is to be understood that these have been included for purposes of explanation only, and are not to be interpreted as limitations of the inventions. Modifications to the embodiments described above can be made without departing from the spirit and scope of the disclosure.

1. A flexible bag, to receive a drink filling, the bag being configured for cooled dispensing through a drink dispensing or serving system and comprising:
a sealed dispensing section; and
a pocket, the pocket being disposed at the flexible bag, freely protruding into the interior of the drink filled bag, and provided from a drink impermeable material, wherein the pocket, when positioned on the inside, includes an opening towards the outside for inserting a flat paddle element having two sections,
wherein the bag is configured such that the drink is brought into motion through a first section of the paddle element, the first section being disposed on the outside of the opening, so that movement is transferred to the drink filling by the second section, the second section being disposed inside the opening, while the inner pocket extending into the interior of the bag jointly moves with the second section.

2. A bag for a drink for cooled dispensing through a drink dispensing or serving system, the bag comprising:
a closeable dispensing section and a filling opening for filling in a drink; and
a pocket connected to the flexible bag, the pocket being made from a material which is impermeable for the drink, the pocket including, in inward protruding state, an opening, which is open to the outside for inserting a flat element into the bag, by means of which the pocket and the filled in with the flexible bag can be brought into a movement, which accelerates the cooling of the drink components.

3. The bag according to claim 2, wherein the pocket is configured as an eversible pocket, and can be everted from a position outside of the bag into a position which freely protrudes into the interior of the bag, before or after filling in the drink.

4. The bag according to claim 2, wherein the inserted flat element and the pocket are configured as a movement unit and adapted to one another.

5. The bag according to claim 2, wherein the flat element is configured as a spatula having a length and supported pivotably in the middle of the length or approximately in the portion of a link between the flexible bag and the pocket.

6. The bag according to claim 2, wherein the pocket is stiffened in its position in the interior of the bag by plate elements for facilitating the insertion of the flat element.

7. The bag according claim 2, wherein the pocket is defined by a liquid tight seam at an element side end towards the bag.

8. The bag according to claim 2, wherein the pocket comprises a greater height than width and a greater length than width.

9. The bag according to claim 2, wherein a dispensing hose is provided as a dispensing section.

10. A drink dispensing system configured for cooled dispensing of a drink, comprising:
a box type container;
a bag configured for insertion into the box type container;
a pocket configured to protrude into the interior of the bag, the pocket comprising an opening towards the outside, and a bisectional flat movement element inserted therein,
wherein the bisectional flat movement element can be brought into a pivoting movement through the first section disposed outside of the bag, so that the bisectional flat movement element can transfer said movement to the drink filling through the second section, disposed on the inside, jointly moving the inner pocket, which protrudes into the interior of the drink filled bag as a movement unit and sealing the bisectional flat movement element towards the drink,
wherein the pocket is made of a drink impermeable material.

11. A method for operating a drink dispensing system comprising:
providing a bag for receiving the drink;
inserting a movement wing from the outside in a pocket everted into an interior of the pocket,
wherein the movement wing is moved for circulating the drink without making direct surface contact with the drink.

12. A method for receiving a drink in a drink dispensing system that includes a bag for receiving the drink, the method comprising:
inserting a movement wing from the outside into an inner bag, which is welded in and which protrudes from the outside into the inner cavity of the drink bag; and
moving the movement wing to circulate the drink without coming into direct surface contact with the drink.

13. The method according to claim 12, wherein the manufacturer fills a finished drink aseptically into the drink bag with a sealed dispensing hose, places it into an outer carton, in order to insert a movement wing into the drink bag and into the inner bag at the dispensing location.

14. The method according to claim 13, wherein the drink bag, comprising a sealed dispensing hose, is placed into a container at the dispensing location, and the movement wing is inserted into the drink bag, and subsequently the drink bag is filled with the drink.

15. The method according to claim 14, wherein the drink bag in its container, in particular in its outer packaging, is cooled down to a specified drink temperature in a cooling and dispensing device, while moving the movement wing.

16. The method according to claim 15, wherein the movement of the movement wing is performed by a drive device provided in the dispensing unit through an upper portion of the movement wing protruding out of the drink bag.

17. The method according to claim 15, wherein the movement wing rests on a roller bearing, and is pivoted about an axis of the roller bearing.

18. The method according to claim 11, wherein the pocket is attached as an eversible pocket in parallel to a seal seam of the drink bag.

19. The method according to claim 18, wherein the eversible pocket is produced in one production step together with producing the seal seam of the drink bag.

20. The method according to claim 12, wherein the inner bag is welded in during a production step for producing the seal seam of the drink bag, in order to produce a prefabricated welded in inner bag in the drink bag.

21. The method according to claim 20, wherein the inner bag is prefabricated.

22. The method according to claim 11, wherein the eversible pocket is mounted at the top of the drink bag, in order to insert the movement wing from the top into the pocket or into the inner cavity of the drink bag.

23. The method according to claim 11, wherein the drink bag is disposed laterally at the drink bag in order to insert the movement wing laterally into the pocket, or into the bag and into the drink bag.

24. The method according to claim 11, wherein the pocket is mounted at the bottom of the drink bag, in order to insert the movement wing from below into the bag and into the drink bag.

25. The method according to claim 13, wherein flat strips are inserted into the inner bag before filling the drink bag with a drink, in order to facilitate receiving the movement wing in the inner bag, when the drink is filled in.

26. A drink dispensing system, comprising a bag in a container, configured for cooled dispensing of a drink, comprising:
a pocket made of a material impermeable for the drink, configured to protrude in the interior of the bag, wherein the pocket is inwardly disposed as an inner pocket and comprises an opening towards the outside;
a bi-sectional flat movement element comprising an outside and an inside portion, configured for insertion in the outside opening of the pocket,
wherein
the bi-sectional flat movement element can be brought into a pivoting movement through its outside portion, disposed outside of the bag, so that said movement can be transmitted to the drink filling by the inserted section of the bi-sectional flat movement element, disposed in the pocket, while jointly moving the inner pocket as a movement unit, which protrudes into the interior of the bag, and seals the bi-sectional flat movement element towards the drink.

27. The drink dispensing system according to claim 26, wherein the inserted bi-sectional flat movement element and the pocket are configured as movement unit and adapted to one another.

28. The system according to claim 26, wherein the bi-sectional flat movement element is provided as a spatula and pivotably supported approximately in the middle of its length, or pivotably supported approximately in the portion of a connection between the bag and the pocket.

29. The system according to claim 26, wherein the pocket comprises a liquid tight seam at an outer end towards the bag.

30. The system according to claim 26, wherein the pocket comprises a greater height than width and a greater length than width, or a dispensing hose is provided as dispensing section.

31. A method for operating a drink dispensing system or for providing a cooled drink for a portioned dispensing from the dispensing system, the method comprising:
receiving a drink with a bag configured to receive drinks;
inserting a movement wing from the outside of the bag into a pocket, which provides an inner cavity of the drink bag;
moving the movement wing to circulate the drink without coming into direct surface contact with the drink.

32. The method according to claim 31, wherein the movement wing is inserted as a movement element from the outside into a welded inner bag as the pocket, which protrudes into the inner cavity of the drink bag,
wherein said movement wing is moved for circulating the drink without coming into a direct surface contact with the drink.

33. The method according to claim 32, using the drink bag, wherein the movement wing is inserted from the outside into the everted inner bag as the pocket, which protrudes into the inner cavity of the drink bag, and wherein said movement wing is moved for circulating the drink without coming into a direct surface contact with the drink.

34. The method according to claim 31, comprising:
aseptically filling a finished drink into the drink bag with a sealed dispensing hose;
placing said drink bag into an outer carton; and
inserting the movement wine into the flexible drink bag and into the pocket as an inner bag at the dispensing location of the finished drink.

35. The method according to claim 32, wherein the inserted movement element and the pocket are configured as a movement unit and adapted to one another.

36. The method according to claim 32, comprising:
inserting plate elements for facilitating the insertion of the movement element, and
wherein the inner pocket in its position in the interior of the bag is stiffened.

37. The method according to claim 32, wherein the pocket is defined by a liquid tight seam, and comprises a liquid tight seam, at an outer end, towards the drink bag.

38. The method according to claim 31, wherein the drink bag, comprising a sealed dispensing hose, is placed into a container at the dispensing location, and the movement element is inserted into the pocket, and the drink bag is subsequently filled with concentrate and water.

39. The method according to claim 31, wherein the drink bag is cooled down to a specified drinking temperature in its container in a cooling and dispensing unit, under movement of the movement element.

40. The method according to claim 31, wherein the movement of the movement element is caused by a drive device, provided in the dispensing unit, through an upper portion of the movement wing protruding from the drink bag.

41. The method according to claim 31, wherein the movement element rests on a roller bearing and is pivoted about an axis of the roller bearing.

42. The method according to claim 31, wherein the pocket is attached as an eversible pocket, in parallel to a seal seam of the drink bag.

43. The method according to claim 42, wherein the eversible pocket is produced in a production step together with producing the seal seam of the drink bag.

44. The method according to claim 32, wherein the inner bag is welded in during a production step, together with producing the seal seam of the drink bag, thereby providing a prefabricated welded inner bag in the drink bag.

45. The method according to claim 31, wherein the inner cavity is prefabricated.

46. The method according to claim 32, wherein the inner bag is attached at the top of the drink bag and the movement element is inserted from the top into the pocket and into the bag and into the interior of the drink bag.

47. The method according to claim 32, wherein the eversible pocket is disposed at the side of the drink bag, and the movement element is inserted laterally into the pocket or into the bag and into the drink bag.

48. The method according to claim 33, wherein the pocket is attached at the bottom of the drink bag, and the movement element is inserted from below into the pocket or into the bag and into the drink bag.

49. The method according to claim 31, wherein flat strips are inserted into the inner cavity, before the drink bag is filled with a drink, in order to facilitate receiving the flat movement element in the inner bag, when the drink is filled in.

50. The drink dispensing system according to claim 26, wherein the inner pocket in its position in the interior of the bag is stiffened by plate elements for facilitating the insertion of the flat movement element.

51. The drink serving system according to claim 26, wherein the bag is received in a box type container, configured for cooled dispensing through the drink dispensing system, wherein the movement element is set in motion by its first section, disposed outside of the bag, so that said motion is transferred to the drinks filling by the inward disposed second section as a paddle element.

52. The flexible bag according to claim 1, wherein the flexible bag is filled with a drink and closed liquid tight.

53. The flexible bag according to claim 1, wherein the inserted flat paddle element and the pocket are configured as a movement unit and adapted to one another.

54. The flexible bag according to claim 1, wherein the pocket is stiffened in its position in the interior of the flexible bag by plate elements for facilitating the insertion of the flat paddle.

55. The flexible bag according claim 1, wherein the pocket is defined by a liquid tight seam at a paddle side end towards the flexible bag.

56. The flexible bag according to claim 1, wherein the pocket comprises a greater height than width and a greater length than width.

57. The flexible bag according to claim 1, wherein a dispensing hose is provided as a dispensing section.
